(19) United States
(12) Patent Application Publication
(10) Pub. No.: US 2008/0082974 A1
(43) Pub. Date: Apr. 3, 2008

(54) Managing Software Component Version Identifications in a Componentised Software System

(76) Inventor: Timothy Peter Ellison, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/858,245

(22) Filed: Sep. 20, 2007

(30) Foreign Application Priority Data
Sep. 28, 2006 (GB) 0619147.2

(51) Int. Cl. G06F 9/44

(52) U.S. Cl. 717/170

(57) ABSTRACT

A method, apparatus and software for managing software component version identifications in a componentised software system in which one or more software components are arranged to export one or more application program interfaces (APIs). The system is arranged to derive meta data defining data structures for APIs exported by a software component and to identify any differences between the meta data and previously derived meta data for the same component so as to enable notification of any identified differences.

### FIELD OF INVENTION

The present invention relates to managing software component version identifications in a componentised software system in which one or more software components are arranged to export one or more application program interfaces (APIs).

### BACKGROUND OF THE INVENTION

Software systems are commonly built from a set of software components in the form of modules, with each module having specific functions and defined interactions with other such modules. There are attempts to provide standardised modularity support in some programming languages and to address the associated issue of component versioning. Versioning applies version identifications in the form of version numbers to each software component, which allow developers to keep track of different development versions of the software components. Versioning enables the decoupling of individual components' development life cycles. When assembling a set of components into a complete system, it is important that the version identifications for each component are compatible with all their interacting components so that a final coherent system is produced.

A commonly used system for specifying version dependencies requires each component to specify a structured version number that indicates the level of interface it implements. The version number is a hierarchical set of revision numbers, each revision number relating to changes of a pre-specified significance within the hierarchy. A widely applied version number system has the following form:

<major revision number>.<minor revision number>.<patch revision number>

The semantics associated with each revision number are typically as follows:

The patch revision number is typically incremented if there are minor bugs fixed in the component release;

The minor revision number is incremented if there are new minor features or a significant number of bug fixes in the release; and

The major revision number is incremented if there are significant changes in functionality.

The problem for component software engineers is identifying when it is appropriate to modify the major or minor revision number. Although there is general consensus that the major revision number should change when there is a breaking component interface change, the rules for determining whether a particular change in a given software language is a breaking change are complex and non-intuitive. Therefore developers often increment the major revision number unnecessarily or miss changes that should result in a major revision change. In the first case each dependent component must unnecessarily be changed to acknowledge the new major revision number, and in the second case the system may fail at runtime due to the overlooked incompatibility. Furthermore, software systems often have dependencies on third-party packages that do not participate in the same componentisation framework. In these cases determining whether the third-party code has made any major or minor revisions between releases is difficult and time consuming.

### SUMMARY OF THE INVENTION

An embodiment provides a method for managing software component version identifications in a componentised software system in which one or more software components are arranged to export one or more application program interfaces (APIs), the method comprising:

a) deriving a first set of meta data defining one or more data structures for one or more APIs exported by a software component;

b) storing the first set of meta data in relation to the software component;

c) deriving a second set of meta data for the software component; and

d) identifying any differences between the second set of meta data and the first set of meta data so as to enable notification of any identified differences.

The method may further comprise:

e) applying a set of compatibility rules to the identified differences, the compatibility rules defining acceptable differences between the sets of meta data so as to enable notification of any contravened rules. At least one of the exported APIs may have an associated version identification and the method may further comprise: if any of the compatibility rules are contravened, applying a set of version identification rules, the version identification rules determining any necessary updates to the version identification of the software component API; and updating the version identification in response to the results of the version identification rules.

The meta data may be derived from a syntax tree created by a compiler for the software component. The meta data may comprise descriptions of the methods, fields and constructors for a given API. The component may be written in Java™ and the compatibility rules embody Java™ binary compatibility rules.

### BRIEF DESCRIPTION OF THE DRAWINGS

Embodiments of the invention will now be described, by way of example only, with reference to the accompanying drawings in which:

FIG. 1 is a schematic illustration of a computer system comprising a componentised software system;

FIG. 2 is a schematic illustration of a system for managing software component version indications in the componentised software system of FIG. 1;

FIG. 3 is a flow chart illustrating processing carried out in the system of FIG. 2; and

FIG. 4 is a flow chart illustrating processing carried out in another embodiment of the system of FIG. 2.

### DETAILED DESCRIPTION OF PREFERRED EMBODIMENTS OF THE INVENTION

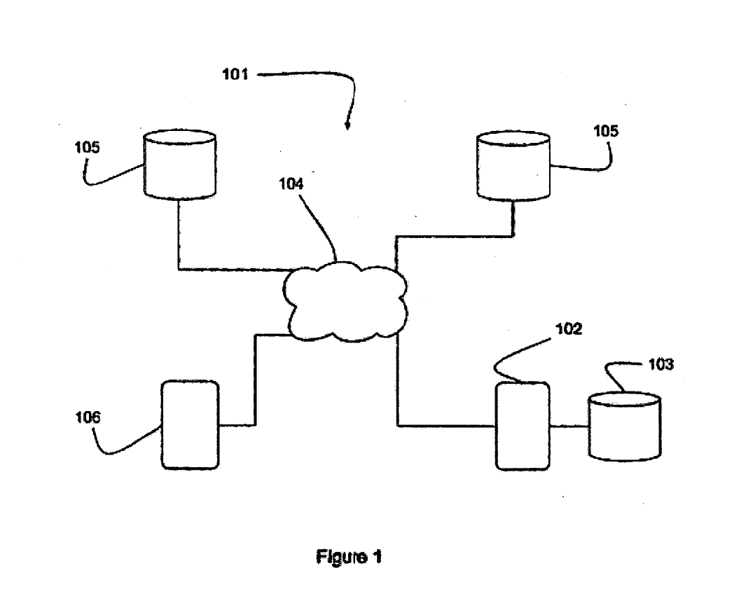

With reference to FIG. 1, a computer system 101 comprises a first computer 102 and an associated database 103. The computer 102 is connected to a network, which interconnects the computer 102 with two further databases 105 and a second computer 106. The first computer runs application software providing a development environment for developing software components for a componentised software system. The software components produced in the development environment on the first computer are stored in the first database 103 and made available, via the network 104, to other development environments running on other computers such as the second computer 106. The databases 105 include software component libraries, which provide a range of ready-made software components for use in the software systems built in the various development environments. In the present embodiment, the development environment on the first computer 102 is the Eclipse™ Java™ Development Toolkit for developing software components in the Java™ programming language.

A software component, also referred to as a module, is effectively defined by two sets of application program interfaces (APIs). An API describes the required inputs and resulting output of a software component. The API generally specifies these inputs and outputs in the form of functions, procedures, variables and data structures. The set of APIs that a module requires to execute successfully, that is its prerequisites, are known as its imports. The set of APIs that it provides for use by other modules are known as its exports. Each component has a manifest that comprises a description of the interfaces it depends upon, its imports, and the interface that it offers to other components, its exports. While various software component systems specify their imports and exports differently, in the present embodiment, the common notation used is that adopted by the Eclipse™ Java™ Development Toolkit.

An abridged example from the manifest of a software component is set out below, which implements functionality in a package namespace called ‘java.nio’:

Bundle-SymbolicName: com.ibm.nio

Import-Package: java.io; version=“[1.0.0,2.0.0)”,

java.lang; version=“[1.1.1,2.0.0)”

Export-Package: java.nio; version=“2.1.0”,

java.nio.channels; version=“2.0.0”

The lines starting “Import-Package:” and “Export-Package:” include version dependencies in the form of version numbers written in standard mathematical set notation. To satisfy these versioning dependencies this module requires other components to export APIs for java.io and java.lang packages from version 1.0.0 inclusive, up to but excluding version 2.0.0 for java.io and from version 1.1.1 to version 2.0.0 for java.lang. In turn this component exports two packages to downstream components, each with specific version numbers. The developer of this module has described their exported API for package java.nio as version 2.1.0. Modules importing this package will assume that java.nio remains compatible unless there is a change in the major revision number. Therefore the developer of this module has to be aware that changes made to the code might result in a need to update the version number if the old code is not compatible with the new updated code.

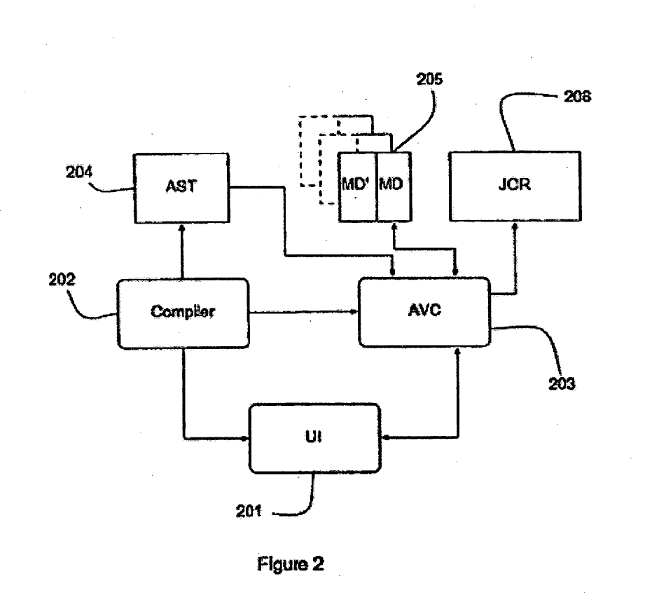

FIG. 2, illustrates elements of the development environment running on the first computer 102 which comprises a development environment user interface (UI) 201, a compiler 202 and an API version checker (AVC) 203. The user interface 201 enables a user to develop software components by creating and editing source code, which can then be compiled, using the compiler 202, into object code for execution. In the present embodiment, the API version checker 203 is arranged to check each software component that is complied and establish whether or not any changes have been made in the code of the component that would result in any of its exported APIs being incompatible with their current version. In other words, the AVC established whether one of more of the components exported APIs should have their version number incremented to indicate to other components that import those APIs that significant change has been made to the way in which the API performs. These significant changes to the exported APIs are referred to as breaking changes in that they cause a break from the agreed or expected performance of the API.

To identify changes in code between one compilation of a given software component and a subsequent compilation of that component, the AVC 203 is arranged to access an abstract syntax tree (AST) 204 produced by the compiler 202 during each compilation of a given component and extract a set of meta data 205 that describes the component's APIs. In the present embodiment, the meta data 205 for each exported API includes each accessible language element in the form of each class, interface, field, as well as each method and each such element's visibility, method return type, parameters, and throws clause. Each set of meta data identifies both the API and its version. The meta data 205 is extracted from the AST 204 each time a component is compiled, thus enabling the meta data 205 for the latest compilation (MD) to be compared to the meta data 205 for the previous compilation (MD′).

Continuing the example above, a sample of the metadata for java.nio (version=“2.1.0”) exported API is as follows:

Contains public class java.nio.ByteBuffer; and

Contains public method ByteBuffer#position with one int argument.

If, between one compilation and the next, the type ByteBuffer were removed from java.nio package, this would result in a breaking change for the importers of this API since they may be relying on the existence of that type. In this case the package export should have its version number updated to java.nio; version=“3.0.0” to denote the breaking change. If, however, the method ByteBuffer#position were to be redefined to take a ‘long’ argument rather than an ‘int’, this would not result in a breaking API change since programs written to call the int version would still work with the version defined as long. This is because the Java™ language rules allow for such a widening of the integer variable. In this case the correct modification to the module metadata would be to define it as java.nio; version=“2.2.0”, indicating that a non-breaking API change was introduced. The rules that determine whether or not a given code change is a breaking change, are referred to as compatibility or equivalence rules and are commonly an integral part of a software language. These rules determine whether or not given software structures or elements are equivalent to one another and therefore compatible. In the present embodiment these rules are in the form of the Java™ binary compatibility rules (JCR) 206.

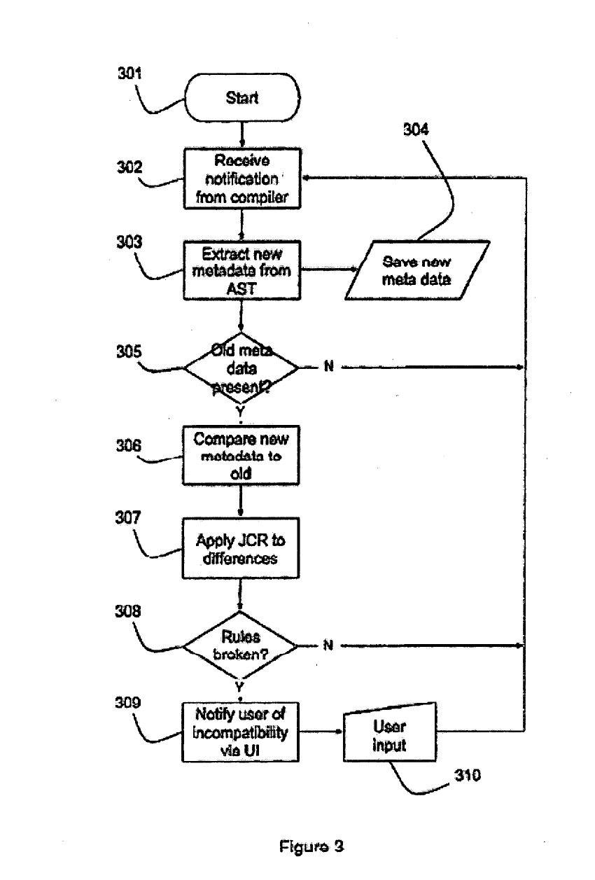

The processing carried out by the AVC 203 will now be described further with reference to the flow chart of FIG. 3. At step 301, the AVC initialises and awaits an indication from the compiler 202 that a software component has been compiled. At step 302, the indication is received from the compiler 302 and processing moves to step 303 where the meta data (MD) 205 is extracted from the latest AST for the component and saved at step 304. Processing then moves to step 305 where the meta data store is checked to determine whether or not a previously extracted set of meta data (MD′) 205 is present for the component. If no previous meta data 205 is present, this indicates that the compilation of the component is its first and processing returns to step 302 and proceeds as described above.

If, at step 305, a previously extracted meta data (MD′) is identified, processing moves to step 306 where the new and old sets of meta data (MD & MD′) 205 are compared so as to identify any differences in the meta data for APIs having the same version numbers. Processing then moves to step 307 where the Java™ compatibility rules (JCR) 206 are applied to any identified differences in the meta data and processing moves to step 308. If at step 308, none of the rules have been broken then this fact is made available to the user via the UI 201 and processing moves to step 302 and continues as described above. If at step 308 rules have been broken then processing moves to step 309 where the changes to the code and an identification of the associated broken rule are provided to the user via the UI 201. Processing then moves to step 310 where an input from the user is awaited. The user is provided with a choice of either backing out of the offending code changes or updating the version identification of the broken API. Backing out of the change will require recompilation of the software component and reanalysis by the AVC 203. If the user chooses to update the version number there is no need to recompile the component and the new metadata is stored and processing ends.

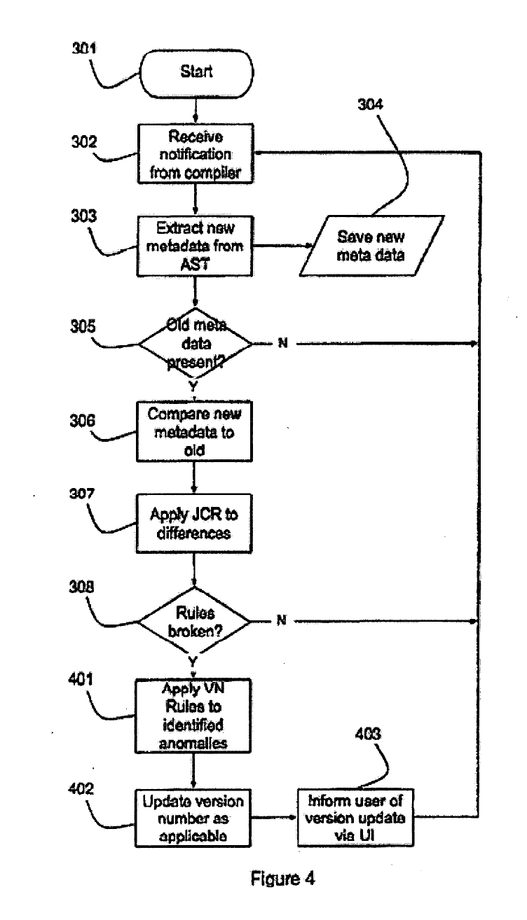

In another embodiment, the AVC further comprises a set of version number rules, which correlate the results of the Java™ binary compatibility rules (JCR) 206 to the version numbering semantics used for the APIs. In other words, if a JCR rule is broken, in a particular case, the version number rules may automatically increment the major version number for the associated API. Similarly, if a less significant compatibility rule is broken, the version number rules may automatically increment the minor version number. The processing carried out by the AVC 203 is the same as in the above embodiment from steps 301 to 308 as shown in FIG. 4. However, after step 308 processing moves to step 401 where the version number rules are applied to any anomalies identified by the JCRs. Processing then moves to step 402 where, if any of the version number rules have been triggered, the version number of the associated API is automatically updated. Processing then moves to step 403 where the user is informed if any of the version numbers for the APIs of the software component have been updated and given the choice of accepting or rejecting the change. If the changes are accepted then the compilation process for the component is completed. If the changes are rejected, the code for the component will need to be edited and then compiled again. Either way, processing returns to step 302 as described above to await further output from the compiler.

In another embodiment, the AVC is arranged to identify any differences in the meta data and to inform the user of those differences. It is then up to the user to determine if those changes break any compatibility rules and to update any associated version number if necessary. In a further embodiment, the version numbering updates provided by the AVC are compulsory. In another embodiment, the version numbering update suggested by the AVC are advisory and may be ignored or over-ridded by a user.

In a further embodiment, the meta data is extracted from the source code by a means other than the AST, such as a separate code parser which extracts code constructs. The AVC may operate prior to compilation. In another embodiment, the metadata is stored as a binary or XML representation of the exported or imported APIs.

In a further embodiment, all of the software components of a software system that is being assembled are checked by the AVC at compile time so that interdependent components all have their dependencies checked. In another embodiment, the functions of the AVC are performed at component link time. In a further embodiment the component dependency information is preserved at runtime, and the AVC functions are performed at runtime rather than development time.

In another embodiment, the AVC checks import version identification compatibility. Where the version number being imported is made explicit, existing tooling will ensure that the import is satisfied by an available component export. However, where no version is dictated then any export will suffice and the meta data for the exporter may be used to determine any breaking API from the importer. In practice this means that breaking an exported API may also break a number of unqualified import dependencies. This is especially useful where the exporter is not participating in the componentisation framework, for example, the imported component is sourced from a third-party library.

As will be understood by those skilled in the art, the above technology may be applied to software components written in other languages that provide for componentisation and APIs or equivalent functions.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of representative apparatus and method, and illustrative examples shown and described. Accordingly, departures may be made from such details without departure from the spirit or scope of applicant's general inventive concept.

1. A method for managing software component version identifications in a componentised software system in which one or more software components are arranged to export one or more application program interfaces (APIs), said method comprising:
a) deriving a first set of meta data defining one or more data structures for one or more
APIs exported by a software component;
b) storing said first set of meta data in relation to said software component;
c) deriving a second set of meta data for said software component; and
d) identifying any differences between said second set of meta data and said first set of meta data so as to enable notification of any identified differences.

2. A method according to claim 1 further comprising:
e) applying a set of compatibility rules to said identified differences, said compatibility rules defining acceptable differences between said sets of meta data so as to enable notification of any contravened rules.

3. A method according to claim 2 in which at least one of said exported APIs has an associated version identification and said method comprises:
f) if any of said compatibility rules are contravened, applying a set of version identification rules, said version identification rules determining any necessary updates to said version identification of said software component API; and
g) updating said version identification in response to the results of said version identification rules.

4. A method according to claim 2 or claim 3 in which said meta data is derived from a syntax tree created by a compiler for said software component.

5. A method according to claim 3 in which said meta data comprises descriptions of the methods, fields and constructors for a given API.

6. A method according to claim 3 in which step d) is performed for a set of interdependent components being assembled.

7. A method according to claim 3 in which step d) is performed at runtime.

8. A method according to claim 3 in which said version identification comprises major and minor revision numbers.

9. A method according to claim 3 in which said component is written in Java™ and said compatibility rules embody Java™ binary compatibility rules.

10. Apparatus for managing software component version identifications in a componentised software system in which one or more software components are arranged to export one or more application program interfaces (APIs), said apparatus comprising:
means for deriving a set of meta data defining one or more data structures for one or more APIs exported by a software component;
means for storing the set of meta data in relation to said software component;
means for comparing the stored set of metadata with a second set of meta data generated by the deriving means for a different version of said software component; and means for identifying any differences between said second set of meta data and said first set of meta data so as to enable notification of any identified differences.

11. Apparatus according to claim 10 further comprising:
means for applying a set of compatibility rules to said identified differences, said compatibility rules defining acceptable differences between said sets of meta data so as to enable notification of any contravened rules.

12. Apparatus according to claims 11 in which at least one of said exported APIs has an associated version identification and said apparatus further comprises means responsive to the contravention of any of said compatibility rules for applying a set of version identification rules, said version identification rules determining any necessary updates to said version identification of said software component API; and
means for updating said version identification in response to the results of said version identification rules.

13. Apparatus according to claim 12 in which the means for deriving the meta data operates on a syntax tree created by a compiler for said software component.

14. Apparatus according to claims 12 in which said meta data comprises descriptions of the methods, fields and constructors for a given API.

15. A storage medium containing computer-readable program code for controlling a computer to manage software component version identifications in a componentised software system in which one or more software components are arranged to export one or more application program interfaces (APIs), said storage medium comprising:
code for deriving a set of meta data defining one or more data structures for one or more APIs exported by a software component;
code for storing the set of meta data in relation to said software component;
code for comparing the stored set of meta data with a second set of meta data generated by the deriving code for a different version of said software component; and
code for identifying any differences between said second set of meta data and said first set of meta data so as to enable notification of any identified differences.

16. The storage medium of claim 15 further comprising:
code for applying a set of compatibility rules to said identified differences, said compatibility rules defining acceptable differences between said sets of meta data so as to enable notification of any contravened rules.

17. Apparatus according to claim 16 in which at least one of said exported APIs has an associated version identification and said storage medium further comprises code responsive to the contravention of any of said compatibility rules for applying a set of version identification rules, said version identification rules determining any necessary updates to said version identification of said software component API; and
code for updating said version identification in response to the results of said version identification rules.

18. The storage medium of claim 16 in which the code for deriving the meta data operates on a syntax tree created by a compiler for said software component.

19. The storage means of claim 16 in which said meta data comprises descriptions of the methods, fields and constructors for a given API.
